(19) United States
(12) Patent Application Publication
(10) Pub. No.: US 2012/0200834 A1
(43) Pub. Date: Aug. 9, 2012

(54) Projector arm assembly for whiteboard stand

(75) Inventor: James Phillips, Kenilworth (CA)

(73) Assignee: COPERNICUS EDUCATIONAL PRODUCTS INC., Arthur (CA)

(21) Appl. No.: 13/136,829

(22) Filed: Aug. 11, 2011

Related U.S. Application Data
(60) Provisional application No. 61/372,765, filed on Aug. 11, 2010.

(51) Int. Cl. G03B 21/10

(52) U.S. Cl. 353/79

(57) ABSTRACT

The invention relates to a folding mounting assembly mounted on a mobile stand for controlling movement of a projector arm, having a projector at one end, from an operable position substantially perpendicular to a screen or other surface mounted on the stand and onto which the projector is intended to project and a closed position parallel to the screen. The assembly comprises a vertical support member that is connectable to the stand and a projector arm mounting means pivotally connected to the vertical support member by means to control the rate of movement of the projector arm mounting means so that it can easily be manually moved from the operable to the closed position and vice versa and will support a projector arm.

### CROSS-REFERENCE TO RELATED APPLICATION

This application claims the benefit of U.S. Provisional Application No. 61/373,765, filed Aug. 11, 2010, and entitled, “PROJECTOR ARM ASSEMBLY FOR WHITEBOARD STAND” which application is incorporated by reference herein in its entirety.

### FIELD OF THE INVENTION

This application relates to a projector arm assembly for an interactive projector system. In particular, the application relates to apparatus for controlling movement of a projector arm from an operable position substantially perpendicular to a screen or other surface onto which the projector is intended to project and a closed position parallel to the screen. The application also relates to an interactive projector system having a screen mounted on a mobile stand and having a moveable arm portion for retaining a projector, the arm being moveable from an operable position substantially perpendicular to a screen or other surface onto which the projector is intended to project and a closed position parallel to the screen.

### SUMMARY OF THE INVENTION

The present invention provides an apparatus for controlling movement of a projector arm from an operable position substantially perpendicular to a screen or other surface onto which the projector is intended to project and a closed position parallel to the screen.

In one embodiment the invention comprises a folding mounting assembly for a projector arm for carrying a projector (either an overhead projector when the screen is an interactive whiteboard or an interactive projector). The folding mounting assembly allows the projector arm to be moveable manually from an operable position substantially perpendicular to a screen or other surface onto which the projector is intended to project and a closed position in which the projector arm is parallel to the screen. The folding mounting assembly may be installed on a mobile stand to create an interactive projector system which includes a screen mounted on the stand and a projector arm and a projector.

In one embodiment the folding mounting assembly comprises a vertical member that is connectable to a stand, a projector arm mounting means pivotally connected to the vertical member by means to control the rate of movement of the arm portion so that it can easily be manually moved from the operable to the closed position and vice versa and will support the projector arm.

The present invention also provides a projector arm mounting assembly for an interactive projector system having a screen mounted on a mobile stand. The screen can be any surface on which an image can be projected but preferably is a whiteboard or interactive white board. The screen is preferably mounted on the mobile stand so that the height of the screen can be adjusted vertically. The projector arm assembly comprises a vertical support member having one end attached to the mobile stand and extending above the top edge of the screen and a moveable arm portion having first and second ends wherein the first end of the moveable arm portion is pivotally connected to the distal end of the vertical support, remote from the mobile stand. Means are provided to control the rate of movement of the arm portion so that it can easily be manually moved from the operable to the closed position and vice versa and will support the arm having the projector mounted to it when in the operable position. If the height of the screen is adjusted vertically the vertical support member preferably is mounted so that the distal end of the vertical support member is retained the same distance from the top edge of the screen. A projector support bracket sized and shaped to retain a front projector, either an overhead projector when the screen is an interactive whiteboard, or an interactive projector, is mounted adjacent the second end of the moveable arm portion in a manner that the projector can project an image onto the screen without obstructing the view of the persons in front of the screen.

In another aspect the present invention provides a projector arm assembly for an interactive projector system having a screen mounted on a mobile stand, the projector arm assembly comprising a vertical support member having one end attached to the mobile stand and extending above a top edge of the screen and a moveable arm having first and second ends wherein the first end of the moveable arm is pivotally connected to the distal end of the vertical support remote from the mobile stand, wherein means are provided to control the rate of movement of the arm so that it can easily be manually moved from an operable to a closed position and vice versa and will support the arm having a projector mounted to it when in the operable position.

The present invention also provides a projector arm wherein the projector arm comprises a pair of spaced apart parallel rails having a perpendicular cross member connecting one end of each of the rails and a vertical member depending from the cross member.

The present invention also provides a projector arm assembly wherein a projector support bracket sized and shaped to retain a front projector is mounted adjacent a second end of a moveable arm in a manner that the projector can project an image onto the screen without obstructing the view of the persons in front of the screen.

The invention also provides a projector arm assembly wherein the means to control the rate of movement of the arm portion so that it can easily be manually moved from the operable to the closed position comprises a pair of tri-lobed brackets fixed to a second end of the depending vertical arm member on the moveable arm portion, the tri-lobed brackets pivotally connected to the distal end of the vertical support member and compression spring means in the form of a pair of gas springs having one end pivotally attached to the tri-lobed brackets and the other end of each of the gas springs attached to the vertical support member.

### BRIEF DESCRIPTION OF THE DRAWINGS

Preferred embodiments of the invention are shown in the drawings, wherein:

FIG. 1 is a front perspective view of a folding mounting assembly, according to one embodiment of the invention, mounted to a mobile stand and adapted for connection of a projector arm for carrying a projector (either an overhead projector when the screen is an interactive whiteboard or an interactive projector) and adapted for connection of means to control the rate of movement of the arm portion so that it can easily be manually moved from the operable to the closed position.

FIG. 2 is a partial front perspective view of the folding mounting assembly of FIG. 1 in a closed position.

FIG. 3 is a partial front perspective view of the folding mounting assembly of FIG. 1 in the closed position, showing the attachment of a projector arm, and means to control the rate of movement of the arm portion so that it can easily be manually moved from the operable to the closed position according to one embodiment of the invention.

FIG. 4 is a partial front perspective view of the folding mounting assembly of FIG. 3, showing the assembly in the operable position.

FIG. 5 is a rear perspective view of the folding mounting assembly of FIG. 4.

FIG. 6 is a front perspective view of the folding mounting assembly of FIG. 2 with showing the underside of the projector arm mounting plate and showing the folding assembly in an operable position.

FIG. 7 is a rear perspective view of the folding mounting assembly of FIG. 2 without the means to control the rate of movement of the arm portion so that it can easily be manually moved from the operable to the closed position and showing the assembly in closed position mounted on a stand.

FIG. 8 is a rear perspective view of the folding mounting assembly of FIG. 6.

FIG. 9 is a perspective view of part of the projector arm mounting means of the folding mounting assembly of FIG. 2;

FIG. 10 is a front perspective view of the projector mounting plate of the folding mounting assembly of FIG. 2.

FIG. 11 is a front perspective view of an interactive projector system having a screen mounted on a mobile stand and a projector arm assembly having a moveable arm portion pivotally connected to the distal end of a vertical support according to one embodiment of the invention. The moveable arm portion is shown in the operable position.

FIG. 12 is a perspective view of the back of the interactive projector system of FIG. 12.

FIG. 13 is perspective view of the projector arm assembly shown in FIGS. 11 and 12.

FIG. 14 is perspective view of the spaced apart parallel rails, cross member connecting one end of each of the rails and vertical member depending from the cross member of the projector arm assembly of FIG. 13.

FIG. 15 is perspective view of the projector support bracket shown in FIG. 13.

FIG. 16 is front perspective view of the mobile stand of FIGS. 11 and 12 without the screen and projector arm assembly.

FIG. 17 is a perspective view of an interactive projector system having a screen mounted on a mobile stand and a projector arm assembly of FIGS. 11 and 12 where the moveable arm is in a closed position.

### DETAILED DESCRIPTION

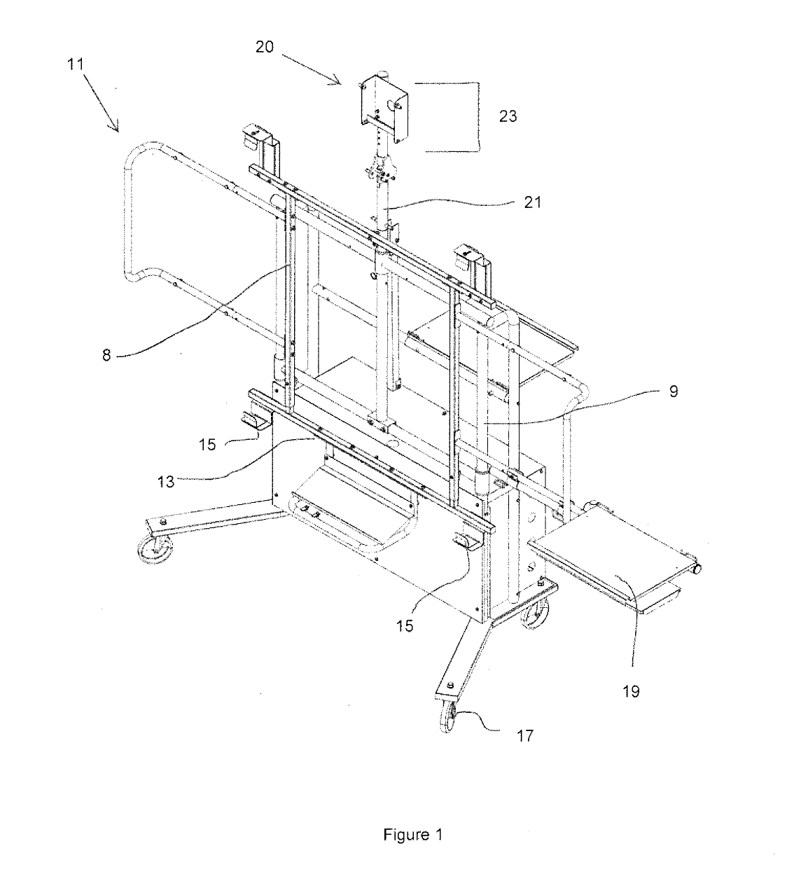

Referring to FIG. 1, one embodiment of apparatus for controlling movement of a projector arm from an operable position substantially perpendicular to a screen or other surface onto which the projector is intended to project and a closed position parallel to the screen according to the present invention is illustrated. In the embodiment shown in FIG. 1, the apparatus of the present invention is shown as a folding mounting assembly, generally indicated at 20, that can be used to control movement of a projector arm (not shown). A projector arm for holding a projector is attachable to the folding mounting assembly. The folding mounting assembly mediates the movement of the projector arm from an operable to a closed position. The folding mounting assembly may be used as part of a system for an interactive projector. For example, as shown in FIG. 1, the system may include a mobile stand 11. The stand includes a ledge 13 and clamps 15 for holding a screen. The stand also includes wheels 17 to make the stand mobile and a tray 19 for holding a laptop. The screen is preferably mounted on the mobile stand so that the height of the screen can be adjusted vertically. The folding mounting assembly 20 has a vertical support member 21 mounted to the stand 11. The movement of a projector arm mounted on the folding mounting assembly (as described below) allows for better storage and transport options of the mobile stand and screen. Also, the movement of the folding mounting assembly allows for the projector position to be adjusted for optimal viewing. The screen is preferably mounted on the stand, so that the height of the screen can be adjusted vertically. In the embodiment shown in FIG. 1, there is a first frame 8 that can be moved relative to a second frame 9 to allow movement of a screen mounted on the first frame 8.

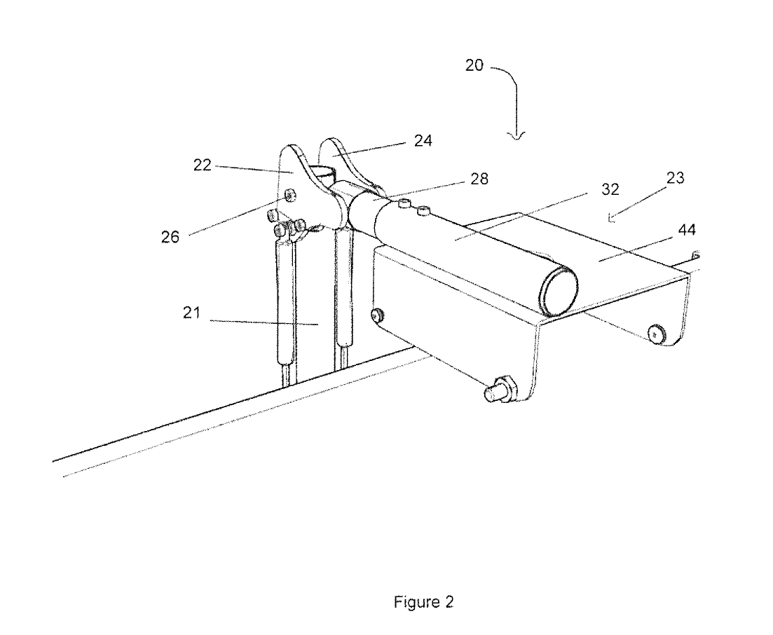

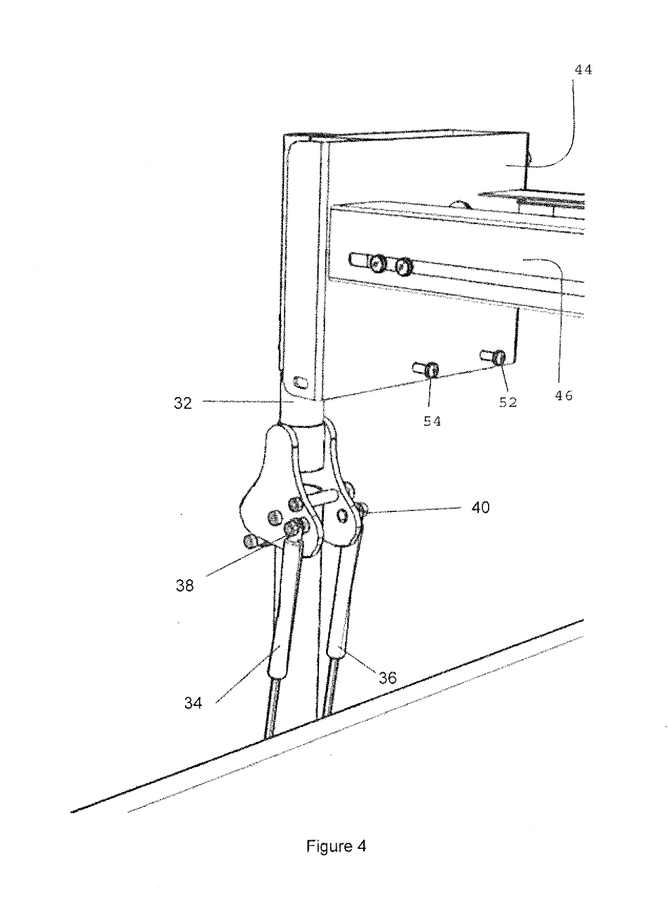

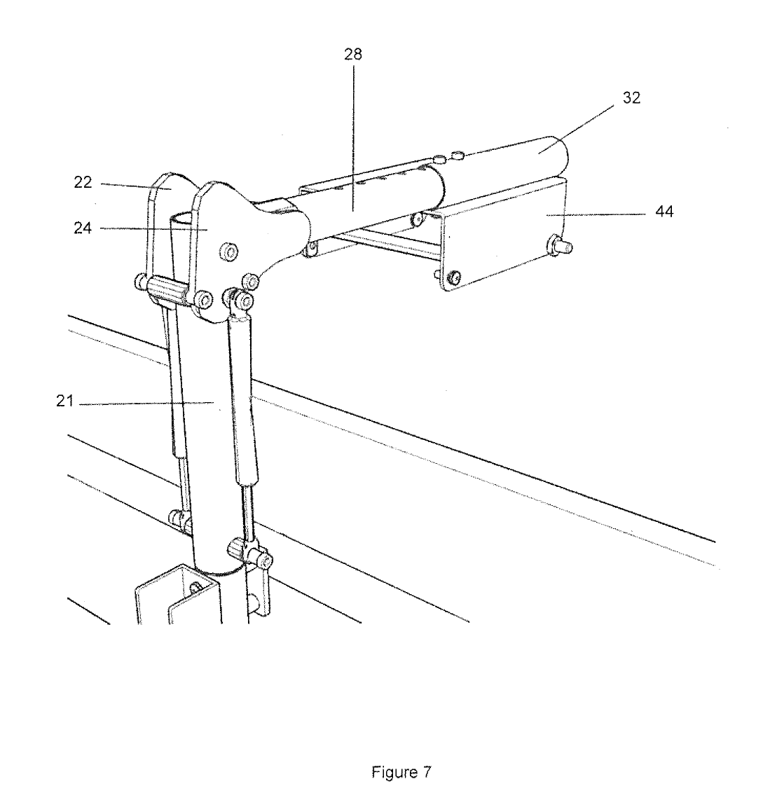

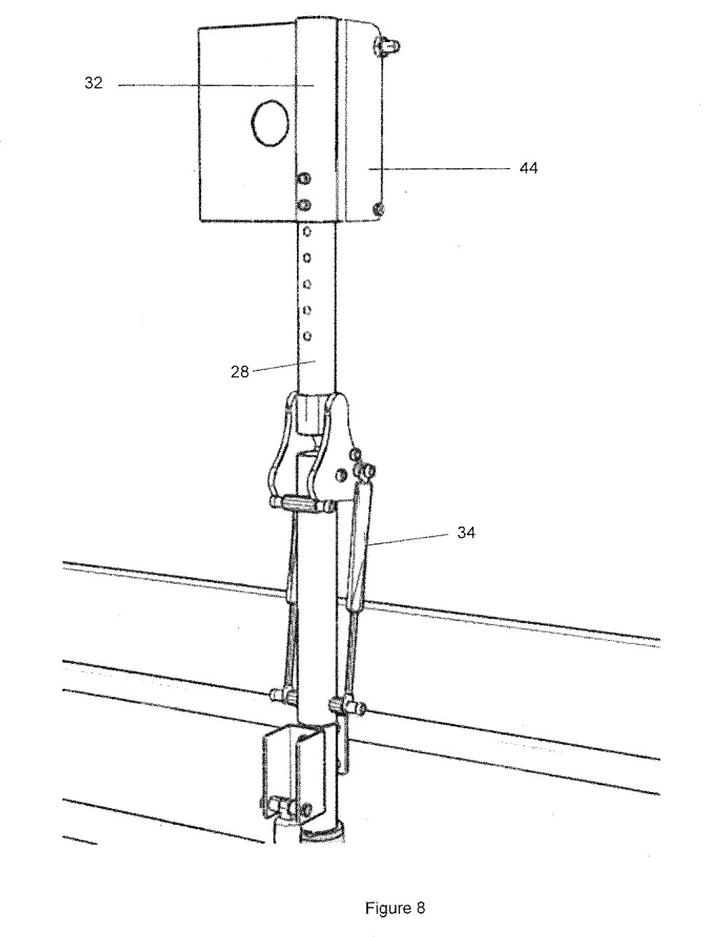

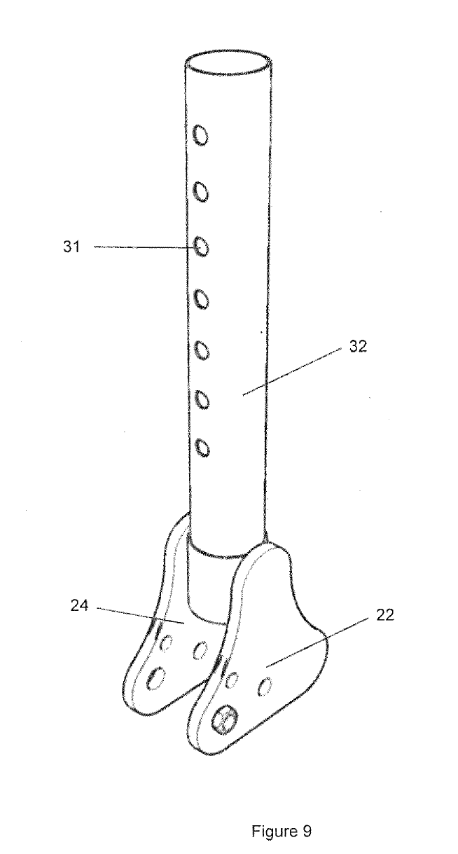

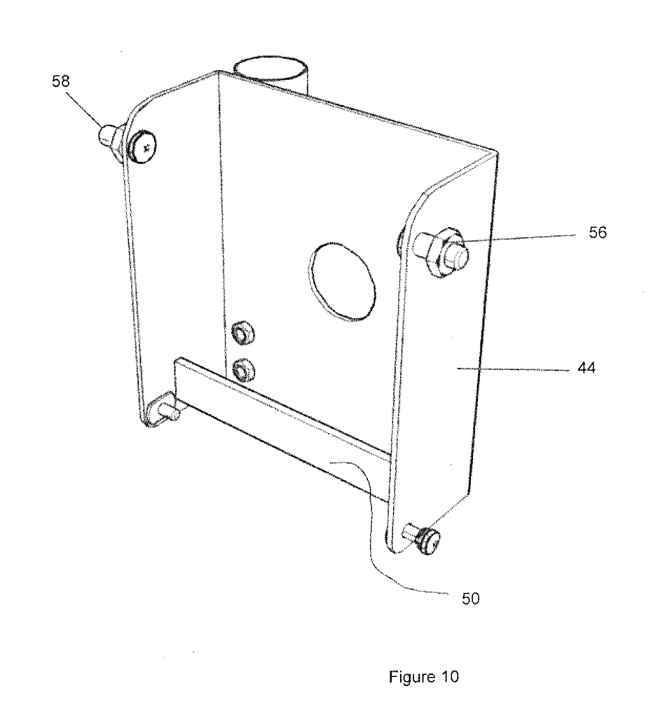

Referring to FIGS. 1-10, the folding mounting assembly 20 comprises a vertical support member 21 that is connectable to a stand 11, a projector arm mounting means generally indicated at 23 pivotally connected to the vertical support member 21 by means to control the rate of movement of the projector arm mounting means so that it can easily be manually moved from the operable to the closed position and vice versa and will support a projector arm. The means to control the rate of movement of projector arm mounting means 23 consists in part, in the embodiment illustrated, of two brackets 22 and 24, shown in the drawings as tri-lobed, pivotally attached at pivot point 26 to the vertical support member 21. One end of each of brackets 22, 24 remote from vertical member 21 is affixed to the projector arm mounting means 23. In the embodiment shown the projector arm mounting means 23 consists of a projector arm tube 28 with a sleeve 32 that is slideable around the tube 28. As seen in FIG. 9, the projector arm tube 28 may have one or more apertures 31 positioned along the length of the tube into which the slideable sleeve 32 may be locked by bolts or spring buttons for example. Provision of the slideable sleeve 32 is optional. It enables the height of the projector arm mounting assembly 23 to extend vertically when the projector arm mounting assembly 23 is in the operable position.

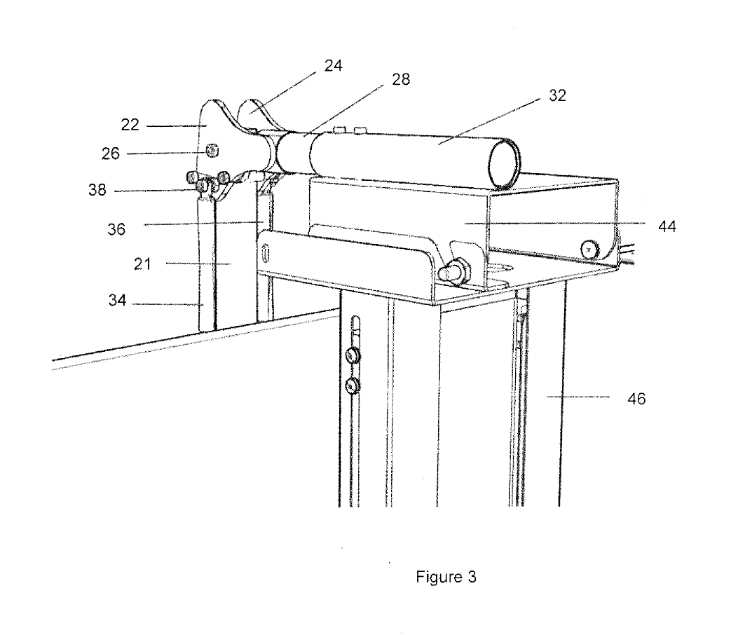

A projector arm mounting bracket 44 is attached, by welding or other suitable fastening means, to the slideable sleeve 32 as shown in the Figures or where the slideable sleeve is not provided directly to the projector arm tube 28. As shown in FIGS. 3-5, the projector arm mounting bracket 44 is designed and shaped to hold a projector arm 46 and is adapted to hold projector arms of different manufacturers. The projector arm 46 holds projector 48 (which may be an overhead projector or an interactive projector).

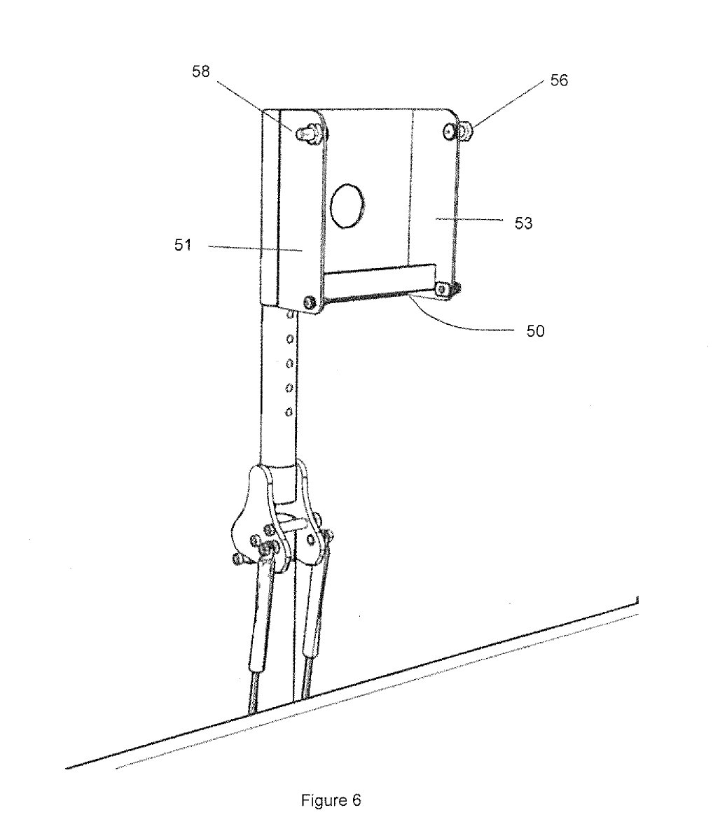

As shown in FIG. 6, the projector arm mounting bracket 44 may have a cross member 50 on the underside to facilitate placement of the projector arm onto the bracket 44. The cross member 50 has two bolts or screws 52 and 54 to facilitate leveling the projector arm by changing the angle of the arm by pushing against the bracket 44. The projector arm mounting bracket 44 also has a pair of flanges 51,53 on opposite sides bracket 44 with a nut and bolt 56,58 or other suitable fastener on each flange 51,53 that can be used to help hold the projector arm 46 to bracket 44.

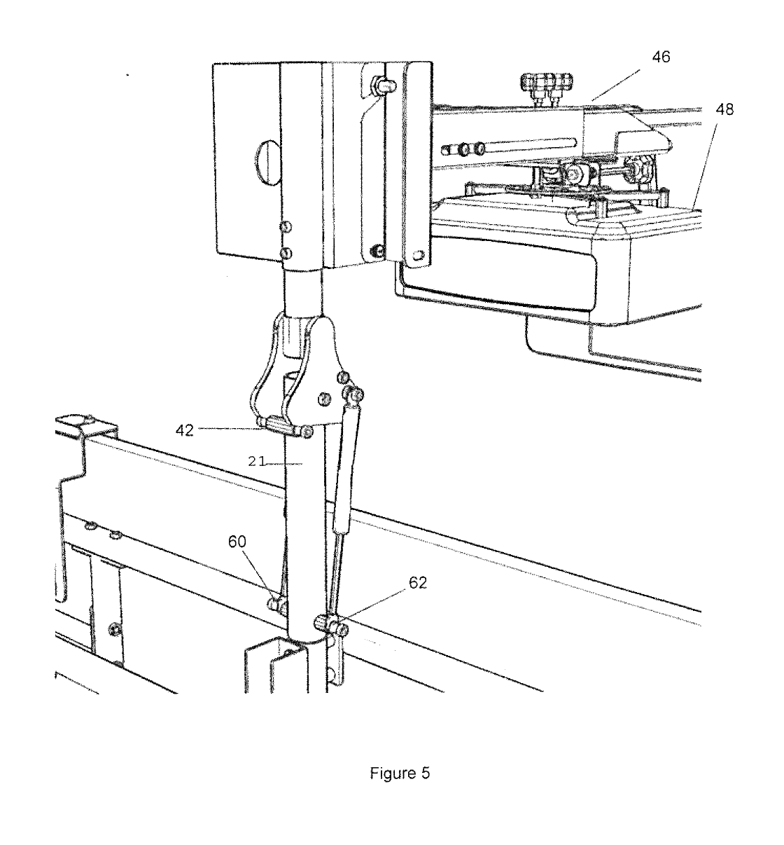

As shown in FIGS. 3-6, the means to control the rate of movement of projector arm mounting means 23 consists not only of brackets 22,24 but also includes gas springs 34,36 having one end attached to the brackets 22,24 by pins 38,40 and the other end attached to the vertical support member 21 at points 60,62. To further support the projector arm mounting means 23 when in the operable position horizontal bar 42 is provided across the back of vertical support member as shown in FIG. 5.

In the embodiment illustrated the folding mounting assembly 20 is designed such that the top end of vertical support member 21 extends above the top edge of any screen which is attached to the stand.

In operation, the folding mounting assembly is capable of moving from an operable position where the projector arm extends out from the mobile stand perpendicular to the screen to a closed position where the projector arm is parallel to the screen. The gas springs allow for easy control, effortless movement, safety and the ability of the projector arm mounting assembly to remain in an open (up) or closed (down) position.

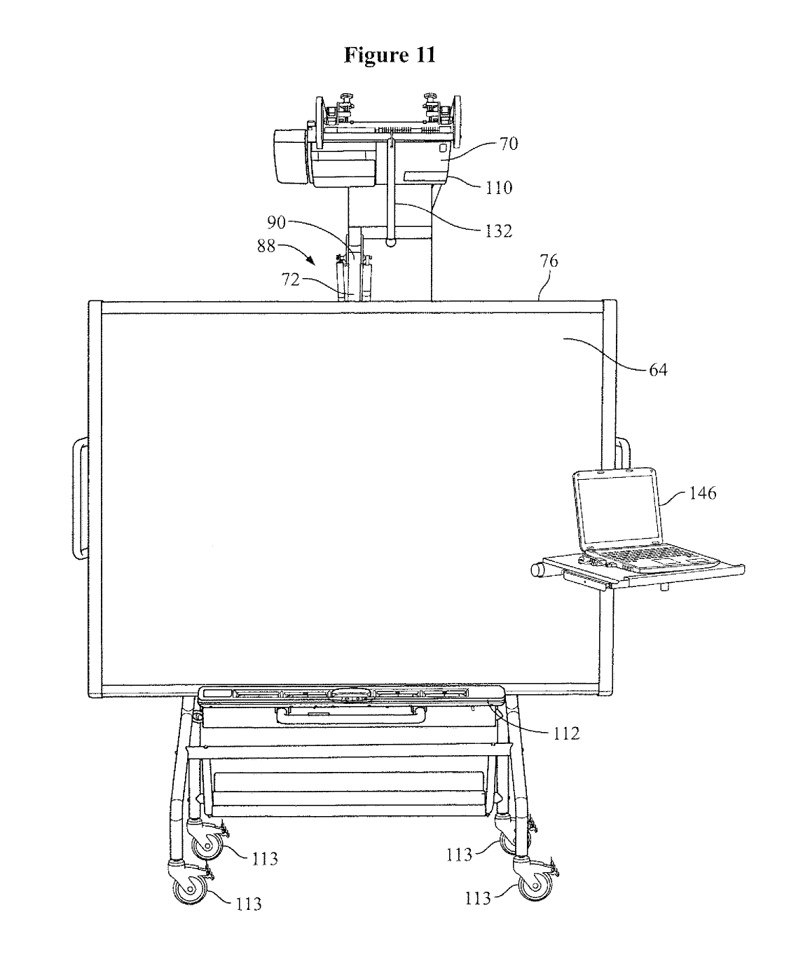

Another embodiment of the invention is shown in FIGS. 11 to 17. In this embodiment, the projector arm assembly includes a projector arm as part of the assembly.

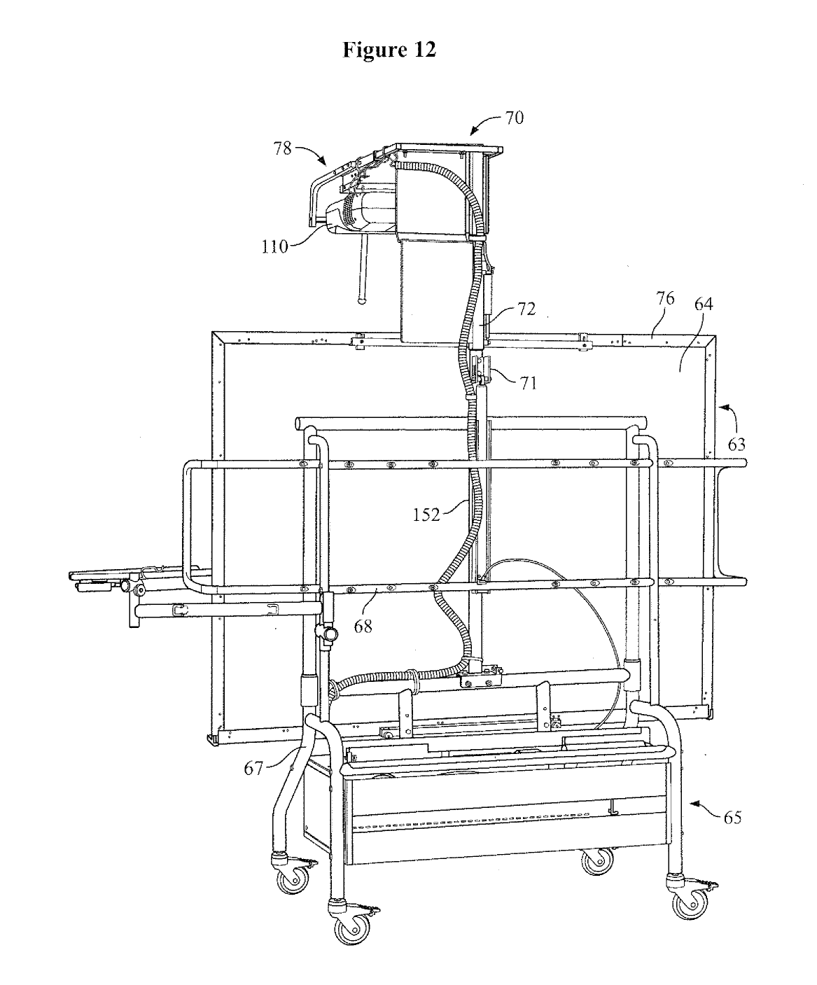

Referring to FIGS. 11 and 12, an interactive projector system generally indicated at 63 according to one embodiment of the present invention is shown having a screen 64 mounted on a mobile stand generally indicated at 65. The screen 64 can be any surface on which an image can be projected but preferably is a whiteboard or interactive white board. The screen 64 is preferably mounted on the mobile stand 65 so that the height of the screen 64 can be adjusted vertically. As best shown in FIGS. 12 and 16, screen 64 is mounted on a first frame 67 that is moveable vertically on a second frame 68. A projector arm assembly generally indicated at 70 is provided.

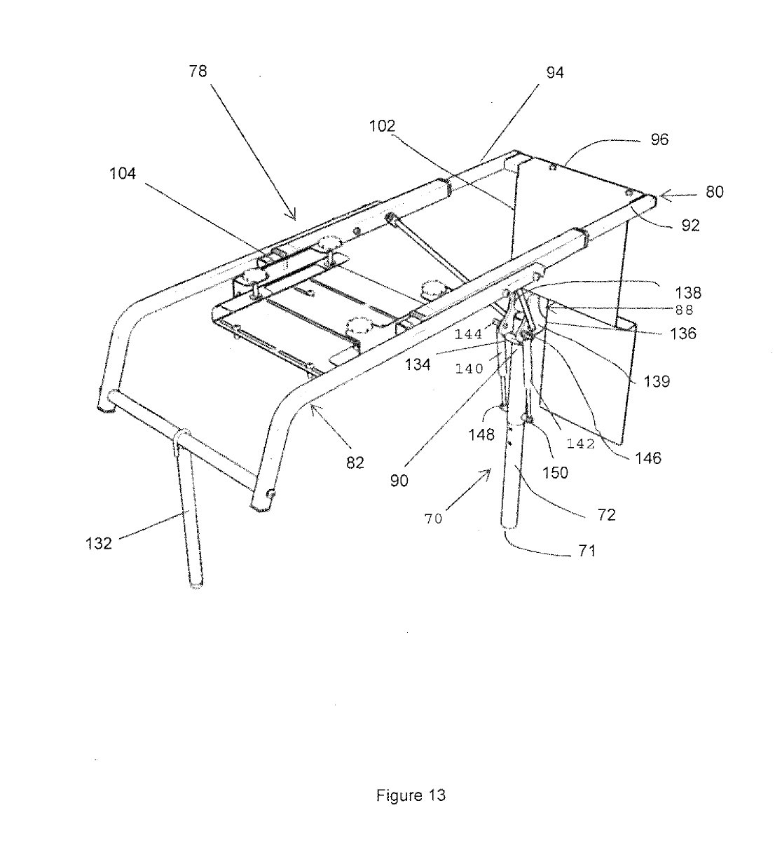

As shown in FIGS. 13, 14 and 15 the projector arm assembly 70 comprises a vertical support member 72 having one end 71 attached to the mobile stand 64 and extending above the top edge 76 of the screen and a moveable arm portion generally indicated at 78 having first 80 and second ends 82 wherein the first end 80 of the moveable arm portion 86 is pivotally connected by motion control means generally indicated at 88 to the distal end 90 of the vertical support member 72, remote from the mobile stand 74. The motion control means 88 controls the rate of movement of the arm so that can easily be manually moved from the operable to the closed position and vice versa and will support the arm having the projector mounted to it when in the operable position. If the height of the screen is adjusted vertically, the distal end of the vertical support member is maintained the same distance from the top edge of the screen.

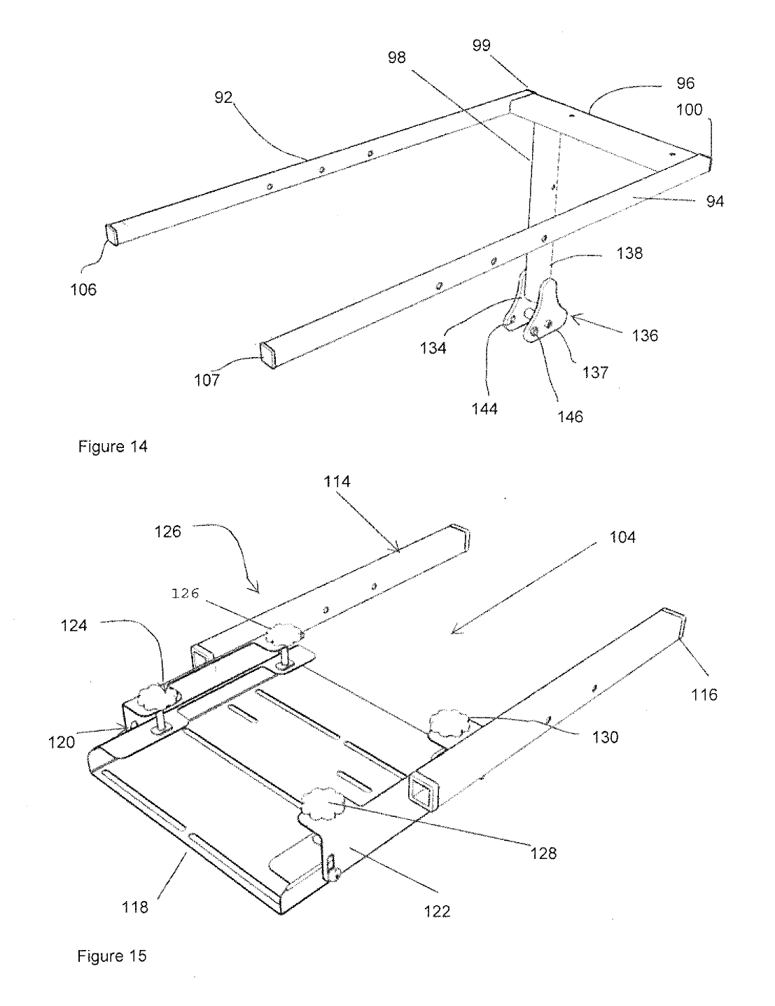

As shown in FIGS. 13 and 14, the moveable arm portion 78 illustrated comprises a pair of spaced apart parallel rails 92, 94 having a perpendicular cross member 96 connecting one end 99, 100 of each of the rails 92, 94 and a vertical arm member 98 depending from the cross member 96. The vertical arm member 98 is connected to the vertical support 72 by motion control means 88 preferably as described below.

A projector support bracket, generally indicated at 104, is adjustably attached to the other ends 106, 108 of the spaced apart rails 92, 94. The projector support bracket 110 is sized and shaped to retain a front projector 112 shown in FIGS. 11 and 12, either an overhead projector when the screen is an interactive whiteboard, or an interactive projector, mounted adjacent the second end 82 of the moveable arm portion 78 in a manner that the projector can project an image onto the screen without obstructing the view of the persons in front of the screen 64.

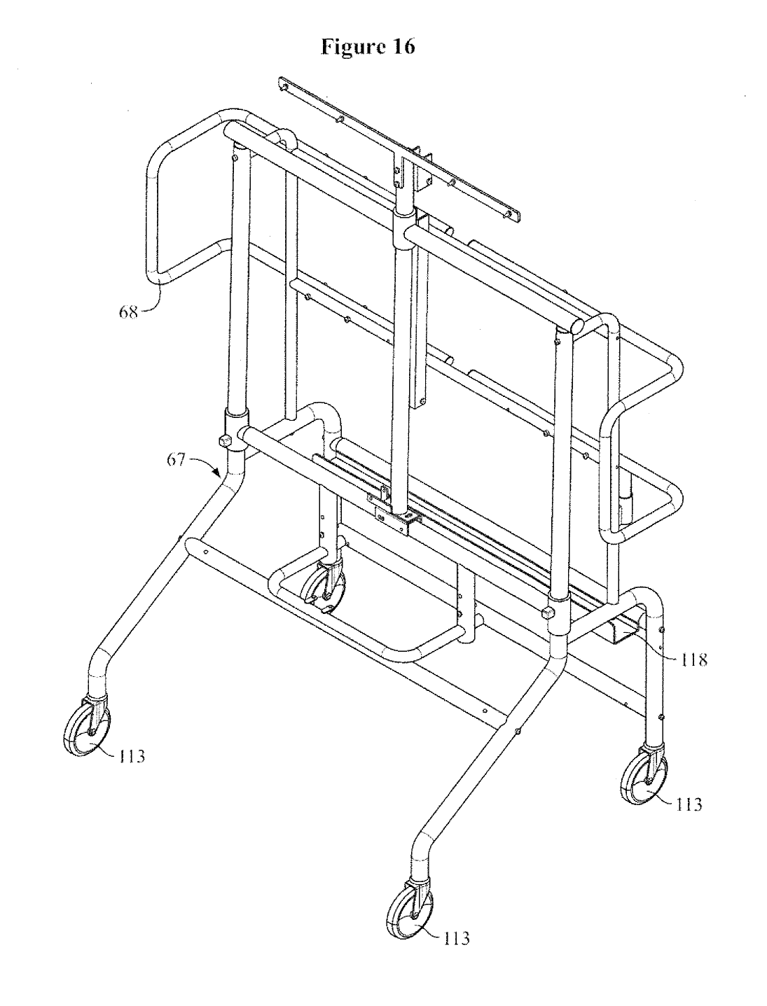

As best shown in FIGS. 13 and 15 the projector support bracket 104 comprises a pair of spaced apart tubular members 114, 116 sized and shaped to be slideably attached to rails 92, 94 of arm portion 78. Plate 118 with upstanding flanges 120, 122 and locking knobs 124, 126, 128, 130 is attached between tubular members 114, 116. The projector 110 is attached to the plate 118. The projector support bracket 110 is adjustable by sliding it along rails 92, 94 so the projector is the right distance from screen 64 when in the operable position.

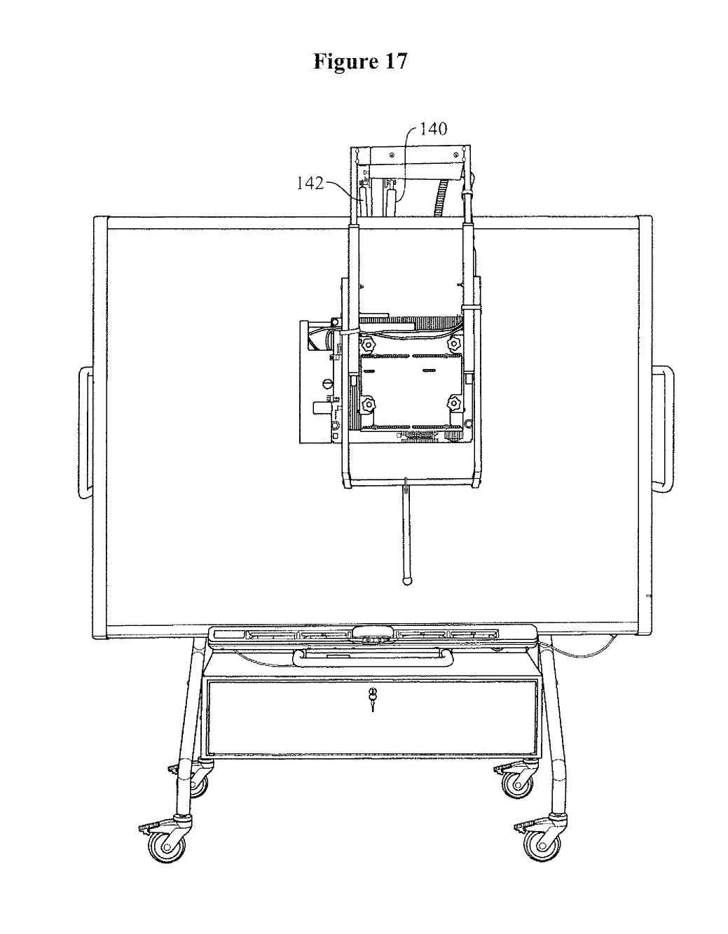

A pull bar 132 is provided at the end 82 of the moveable arm portion 78 to enable a person to reach up and pull down on the projector arm assembly 70 to move it from the operable position to the closed position shown in FIG. 17.

In the embodiment shown in the Figures, the stand 65 includes a shelf-like structure, ledge or drawer 118 for supporting the screen 64. The stand 65 has wheels 120 to allow for easy transportation of the system. A computer such as a laptop 146, shown in FIG. 11 is coupled to the system.

The movement of the projector arm assembly into the closed position shown in FIG. 17 allows for better storage and transport options. The arm components are preferably tubular so that electronic components for operation of the projector run through it.

As noted above the projector arm assembly 70 includes a motion control device 88 to control the movement of the arm from an operable position to a closed position and vice versa. In the embodiment shown in the Figures, the motion control device 88 includes a pair of tri-lobed brackets 134, 136 fixed to the end 138 of the depending vertical arm member 98 (see FIG. 14) on the arm portion 78. The tri-lobed brackets 134, 136 are pivotally connected to the distal end 90 of the vertical support member 72 by pin 137. Compression spring means in the form of a pair of gas springs 140, 142 have one end pivotally attached to the tri-lobed brackets 134, 136 at points 144, 146. The other end of each of the gas springs 140, 142 is attached to the vertical support member 72 at pin points 148, 150. The gas springs allow for easy control, easy effortless movement, safety, and the ability for the projector arm to remain in an open (up) or closed (down) position. This is also illustrated in FIG. 14, where projector 48 attached to moveable arm portion 78 is positioned to face the screen or board 64.

As shown in FIGS. 12 and 16, the stand 65 may be formed from a series of inter-connecting hollow members oriented in both the horizontal and vertical direction. For example, in the embodiment shown in FIG. 12, there is a centre vertical support member 152 on which the projector arm assembly 70 may be mounted. Other configurations are possible, provided that the screen 64 is supported on the stand 65 and that the stand 65 is capable of holding the screen or board.

The gas springs allow the arm to be moved in a controlled fashion. Thus, it is possible to move the projector to a position to allow for optimal viewing of the information on the board or screen. The arm would move through 90 degrees until the projector faces the board.

Generally, a dry erase board or whiteboard, which may be mounted on the stand, for example, is placed at the front of a classroom or in front of the group being presented to. It is sometimes necessary to adjust the height or angle of the projector for optimal viewing. It is also sometimes necessary to move the board between classrooms or conference rooms. The present invention enables the interactive projector system to be moved to any location for optimal viewing including between rooms or to a storage location. The ability of the arm to be pivoted downward allows the system to become more compact, thereby assisting in ease of transport. The projector may be folded or collapsed independently of the board or frame.

Further, since the screen or board need not be attached to the stand, the stand may be folded up, stored and transported independently of the board. The illustrated system includes a whiteboard. However, the invention can be used for other types of boards and display surfaces.

The moveable arm can be used in conjunction with a known interactive whiteboard such as SMART®Board interactive whiteboard produced by Smart Technologies (Calgary, Alberta). Alternatively, the mobile arm can be used with an interactive projector such as the one produced by Epson (Nagano, Japan).

The preferred embodiment of the present invention was designed specifically for educators and incorporates technology with traditional teaching in one center. Its compact size allows for whole class teaching or small group instruction with less distractions. Combining the functionality of an Interactive Projector with a Magnetic Dry Erase Board. The projector arm supports an EPSON BrightLink 450Wi Interactive Projector.

Use of the gas springs or other compressible spring means and pull down handle permits a teacher to easily reach up to grab the pull down handle to easily fold the projector down for storage or transporting or push the arm back up into the operable position. In a preferred embodiment the projector system moves with ease, folds compact to 31″D (79 cm) to fit through the average doorway in a school or office.

Locking Casters can be installed to ensure the unit stays in place when bumped.

The laptop/Keyboard shelf preferably easily swivels into position with a slide out shelf for increased work space.

A Wire Management System can be included to keeps cords neat and power source organized, reducing tripping hazard.

It is to be understood by one of ordinary skill in the art that the present discussion is a description of exemplary embodiments only, and is not intended to limit the broader aspects of the present invention.

Although various preferred embodiments of the present invention have been described herein in detail, it will be appreciated by those skilled in the art that variations may be made thereto without departing from the spirit of the invention or the scope of the appended claims.

1. A folding mounting assembly mounted on a mobile stand for controlling movement of a projector arm, having a projector at one end, from an operable position substantially perpendicular to a screen or other surface mounted on the stand and onto which the projector is intended to project and a closed position parallel to the screen comprising a vertical support member that is connectable to the stand and a projector arm mounting means pivotally connected to the vertical support member by means to control the rate of movement of the projector arm mounting means so that it can easily be manually moved from the operable to the closed position and vice versa and will support a projector arm.

2. The folding mounting assembly of claim 1 wherein the means to control the rate of movement of projector arm mounting means consists of two brackets pivotally attached to the vertical support member and having one end of each of brackets remote from the vertical support member affixed to the projector arm mounting means and compression spring means in the form of a pair of gas springs each having one end attached to one of the brackets and the other end of each of the gas springs attached to the vertical support member.

3. The folding mounting assembly of claim 1 or 2, wherein the projector arm mounting means consists of a tube having one end attached to the brackets pivotally connected to the vertical support member and a projector arm mounting bracket adapted to be attached to the other end of the tube.

4. The folding mounting assembly of claim 3 wherein the projector arm mounting bracket is connected to one end of a slideable sleeve surrounding the tube, wherein the sleeve can be moved along the tube and locked into position along the tube.

5. The folding mounting assembly of any one of claims 1 to 4, wherein the brackets are tri-lobed.

6. A projector arm assembly for an interactive projector system having a screen mounted on a mobile stand, the projector arm assembly comprising a vertical support member having one end attached to the mobile stand and extending above a top edge of the screen and a moveable arm having first and second ends wherein the first end of the moveable arm is pivotally connected by motion control means to the distal end of the vertical support, remote from the mobile stand, wherein the motion control means controls the rate of movement of the arm so that it can easily be manually moved from an operable to a closed position and vice versa and will support the arm having a projector mounted to it when in the operable position.

7. A projector arm assembly according to claim 6 wherein a projector support bracket sized and shaped to retain a front projector is mounted adjacent a second end of the moveable arm in a manner that the projector can project an image onto the screen without obstructing the view of the persons in front of the screen.

8. A projector arm assembly according to claim 6 wherein the moveable arm comprises a pair of spaced apart parallel rails having a perpendicular cross member connecting one end of each of the rails and a vertical member having one end fixed to the cross member and depending from the cross member.

9. A projector arm assembly according to claim 8 wherein the motion control device comprises a pair of tri-lobed brackets fixed to a second end of the depending vertical arm member on the moveable arm portion, the tri-lobed brackets pivotally connected to the distal end of the vertical support member and compression spring means in the form of a pair of gas springs have one end pivotally attached to the tri-lobed brackets and the other end of each of the gas springs attached to the vertical support member

10. An assembly for controlling the movement of a projector arm comprising:
a depending vertical support member;
an upstanding vertical support member;
a pair of tri-lobed brackets fixed to one end of the depending vertical support member and one end of the upstanding vertical member;
a pair of compression springs having one end pivotally attached to the tri-lobed brackets and the other end of each of the compression springs attached to the vertical support member at a point distal from the tri-lobed brackets;
a projector arm mounting portion for holding a projector; wherein the assembly is attachable to a mobile stand.

11. A projector arm assembly for an interactive projector system comprising:
a vertical support member having one end attached to a mobile stand and extending above the top edge of the screen;
a moveable arm portion having first and second ends wherein the first end of the moveable arm portion is pivotally connected by motion control means to the distal end of the vertical support;
a projector support bracket sized and shaped to retain a projector mounted adjacent to the second end of the moveable arm portion in a manner that the projector can project an image onto the screen without obstructing the view of the persons in front of the screen.
